(19) United States
(12) Patent Application Publication
(10) Pub. No.: US 2021/0336291 A1
(43) Pub. Date: Oct. 28, 2021

(54) SOLID THIOPHOSPHATE ELECTROLYTE COMPOSITION FOR LITHIUM-BASED BATTERIES

(71) Applicant: UT-Battelle, LLC, Oak Ridge, TN (US)

(72) Inventors: Jagjit Nanda, Knoxville, TN (US); Ethan C. Self, Knoxville, TN (US); Frank M. Delnick, Maryville, TN (US)

(21) Appl. No.: 17/236,347

(22) Filed: Apr. 21, 2021

Related U.S. Application Data
(60) Provisional application No. 63/013,577, filed on Apr. 22, 2020.

(51) Int. Cl. H01M 10/0562; H01M 10/0525; C01B 25/30

(52) U.S. Cl. CPC H01M 10/0562; H01M 10/0525; H01M 2300/0065; C01P 2002/02; C01B 25/30

(57) ABSTRACT

A solid electrolyte (SE) composition comprising a homogeneous blend of lithium thiophosphate particles and a polyalkylene oxide, wherein the lithium thiophosphate particles have the formula xLi₂S.(1−x)P₂S₅ wherein x is a value within a range of 0.5-0.9, and wherein said polyalkylene oxide is present in an amount of 0.1-10 wt % of the solid electrolyte. Also described herein is a solid-state lithium-based battery comprising: a) an anode; (b) a cathode; and c) the SE composition described above. Further described herein is a method for producing the SE composition, comprising: (i) homogeneously mixing Li₂S, P₂S₅, a polyalkylene oxide, and a solvent to form a liquid solution or liquid homogeneous dispersion, and (ii) heating the liquid solution or liquid homogeneous dispersion produced in step (i) to remove the solvent and produce the SE composition.

### CROSS REFERENCE TO RELATED APPLICATION

The present application claims benefit of U.S. Provisional Application No. 63/013,577, filed on Apr. 22, 2020, all of the contents of which are incorporated herein by reference.

### GOVERNMENT SUPPORT

This invention was made with government support under Prime Contract No. DE-AC05-000R22725 awarded by the U.S. Department of Energy. The government has certain rights in the invention.

### FIELD OF THE INVENTION

The present invention generally relates to solid electrolyte (SE) compositions for lithium-based batteries, and more particularly, to solid electrolyte compositions having a thiophosphate composition. The present invention is also directed to methods for producing the solid electrolyte. The present invention is also directed to lithium-based batteries containing the solid electrolyte.

### BACKGROUND OF THE INVENTION

A critical challenge for Li-based solid-state batteries (SSBs) is the development of solid electrolytes (SEs) which exhibit: (i) high Li⁺ conductivity comparable to that of liquid organic electrolytes and (ii) good electrochemical and mechanical compatibility with lithium metal anodes and high energy density cathodes. Nano-crystalline β-Li₃PS₄ represents a promising SE candidate due to its high ionic conductivity (1.5×10⁻⁴ S/cm at room temperature). However, a significant obstacle for commercializing this material and related sulfide-based SEs is the lack of scalable processing methods to produce thin films, typically less than 30 μm thick, which are critical for high energy density SSBs (Z. Liu et al., J. Am. Chem. Soc., 2013, 135, 975). Furthermore, the nano-/polycrystalline structure of many SEs may result in non-uniform current densities and unstable Li growth during battery operation (J. A. Lewis, et al., Trends in Chemistry 2019, 1, 845).

Sulfide-based SE powders are typically synthesized using either: (i) high temperature mechanochemical methods or (ii) solvent-mediated routes in which the precursors (e.g., Li₂S and P₂S₅) are dispersed in an organic solvent (e.g., tetrahydrofuran, acetonitrile, or ethyl acetate) followed by drying and thermal annealing (M. Ghidiu, et al., J. Mater. Chem. A 2019, 7, 17735). The latter approach has been used to fabricate a wide range of Li—P—S ternary crystalline compounds (e.g., β-Li₃PS₄, Li₇P₃S₁₁, and Li₇PS₆) and metal/halide-substituted materials (e.g., 0.4LiX.0.6Li₄SnS₄ and Li₆PS₅X, X═Cl, Br, I) with Li⁺ conductivities ≥1×10⁻⁴ S/cm at room temperature. As detailed in prior reviews (e.g., J. Xu, et al., Materials Today Nano 2019, 8), solvent-mediated synthesis leads to products with structures and electrochemical properties that are greatly dependent on the composition, solvent, mixing protocol, and thermal post-treatment, and this generally results in substantial variability and inconsistent results.

The Li⁺ conductivity of sulfide-based SEs is closely linked to the material's microstructure and local Li bonding environments. With respect to crystalline Li₃PS₄, two phases exist at room temperature, namely the bulk γ phase and the nanostructured β phase. Moreover, to develop Li-based SSBs with energy densities >350 Wh/kg, the SE layer should generally be less than 30 μm thick to compete with classic LIBs using polymer separators (X. Judez, et al., Joule 2018, 2, 2208). However, due to difficulties in producing scalable thin-film ceramics, most SSB research utilizes SE pellets (ca. 0.5-1 mm thick) in which the SE occupies a large mass and volume fraction of the cell. This leads to lower volumetric and gravimetric energy density.

### SUMMARY OF THE INVENTION

In one aspect, the present disclosure is directed to a solid electrolyte (SE) composition possessing (i) suitable Li⁺ conductivity, possibly comparable to that of liquid organic electrolytes and (ii) good electrochemical and mechanical compatibility with lithium-containing anodes and high energy density cathodes. The SE composition includes a homogeneous blend of lithium thiophosphate particles and a polyalkylene oxide (PAO), wherein the lithium thiophosphate particles have the formula xLi₂S.(1−x)P₂S₅, wherein x is a value within a range of 0.5-0.9, and wherein the polyalkylene oxide is present in an amount of 0.1-10 wt % of the SE.

In another aspect, the present disclosure is directed to a lithium-based battery containing the above-described solid electrolyte. The lithium-based battery includes: a) an anode; (b) a cathode; and (c) the solid electrolyte composition described above. The composites containing PAO binder can potentially be integrated into thin solid electrolyte separators which are critical for solid state batteries with high energy density.

In another aspect, the present disclosure is directed to a method for producing the above-described SE composition. The method includes: (i) homogeneously mixing Li₂S, P₂S₅, a polyalkylene oxide (PAO), and a solvent to form a liquid solution or liquid homogeneous dispersion of the Li₂S, P₂S₅, and PAO in the solvent, wherein the solvent at least partially dissolves Li₂S, P₂S₅, and the PAO; and (ii) heat treating the liquid solution or liquid homogeneous dispersion produced in step (i) at a temperature of 60-300° C. to remove the solvent and produce the solid electrolyte composition described above. In particular embodiments, the above-described method is practiced as a one-pot synthesis for the production of amorphous and/or crystalline xLi₂S.(1−x)P₂S₅/PAO composite SEs (or more particularly, Li₃PS₄/PAO composite SEs) in which the PAO serves as a binder to improve material processability. Here, the Li₃PS₄ is synthesized in situ by blending the Li₂S, P₂S₅, and PAO in acetonitrile or an ether solvent (or other suitable solvent, as further described below) followed by thermal annealing (see, e.g., the schematic in FIG. 1). The solvent is removed after thermally annealing the electrolyte at a suitably elevated temperature (typically, e.g., 140-250° C.). This approach permits production of a wide range of composites in which the Litconducting phase (Li₃PS₄) is intimately blended with the polymer binder.

### BRIEF DESCRIPTION OF THE DRAWINGS

FIG. 1. Schematic illustrating the solvent-mediated synthesis of Li₃PS₄ and Li₃PS₄/PEO composite SEs studied. While the synthesis in THF led to formation of crystalline β-Li₃PS₄ after heating at 140° C., syntheses performed in acetonitrile (AN) resulted in primarily amorphous Li₃PS₄ after heating to 140-250° C. In situ synthesis of Li₃PS₄ in the presence of PEO permits production of a wide range of composites in which the Li⁺ conducting phase (Li₃PS₄) is intimately blended with the polymer binder (PEO). The abbreviations THF, AN, and PEO denote tetrahydrofuran, acetonitrile, and poly(ethylene oxide), respectively.

FIG. 2. Powder XRD patterns of Li₃PS₄ prepared using THF and AN solvents and annealed at 45-250° C. The broad background at 20-30 ° is due to the Kapton film which was used to mitigate air exposure during the measurements. Syntheses conducted in THF resulted in crystalline β-Li₃PS₄ whereas using AN resulted in an amorphous Li₃PS₄ phase.

FIG. 3. Powder XRD patterns of Li₃PS₄ and Li₃PS₄+PEO composites containing 0.2-56 wt. % PEO prepared using AN and annealed overnight at 140° C. The amorphous Li₃PS₄+PEO composites had similar structures compared to that of the amorphous Li₃PS₄ obtained from AN.

FIGS. 4A-4D. Li⁺ conductivity measurements of β-Li₃PS₄ and Li₃PS₄+PEO composites. FIG. 4A: Schematic of the electrochemical cell. FIG. 4B: representative Nyquist plots collected at different temperatures. FIGS. 4C-4D: Arrhenius plots showing Li⁺ conductivity as a function of temperature for Li₃PS₄+1 wt. % PEO dried at 25 and 140° C. (FIG. 4C), and Li₃PS₄+PEO composites containing 0.2-56 wt. % PEO (FIG. 4D). AC perturbations of 500 mV were used for Li₃PS₄+1% PEO dried at 25° C. (FIG. 4C) and Li₃PS₄+56% PEO dried at 140° C. (FIG. 4D) due to the high resistance of these samples.

### DETAILED DESCRIPTION OF THE INVENTION

In one aspect, the present disclosure is directed to a solid electrolyte (SE) composition containing a homogeneous blend of (i) lithium thiophosphate particles and (ii) a polyalkylene oxide (PAO). The term “homogeneous blend,” as used herein, indicates a solid solution in which discrete microscopic regions of components (i) and (ii) are present but dispersed evenly and regularly throughout the composition. The polymer blend generally exhibits substantial integration at the microscale or nanoscale level without losing each component's identity. Generally, particles of component (i) are homogeneously dispersed in a matrix of component (ii), or more particularly, component (ii) functions as a binder for particles of component (i). More specifically, particles of component (i) are dispersed homogeneously throughout the matrix or binder composed of component (ii).

The term “lithium thiophosphate,” as used herein, is defined as any composition within the generic formula xLi₂S.(1−x)P₂S₅ wherein x is a value within a range of 0.5-0.9. In particular embodiments, x may be, for example, 0.5, 0.55, 0.6, 0.65, 0.7, 0.75, 0.8, 0.85, or 0.9, or x may be within a range bounded by any two of the foregoing values (e.g., 0.55-0.9, 0.6-0.9, 0.55-0.85, or 0.6-0.85). In the particular case where x=0.75, the lithium phosphate composition corresponds to the formula Li₃PS₄. In the particular case where x=0.5, the lithium phosphate composition corresponds to the formula LiPS₃. The lithium phosphate may or may not be co-crystallized with a solvent. An example of a lithium phosphate co-crystallized with a solvent is Li₃PS₄.3THF (where THF=tetrahydrofuran). The lithium phosphate particles may be amorphous or crystalline or include qualities of both (quasi-crystalline or glass ceramic).

The lithium thiophosphate particles can be of any suitable size, but generally the average size or maximum size is no more than 100 microns. In different embodiments, the lithium thiophosphate particles have an average size or substantially uniform size of precisely or about, for example, 0.01, 0.05, 0.1, 0.2, 0.3, 0.4 0.5, 0.6, 0.7, 0.8, 1, 2, 5, 10, 20, 50, or 100 microns, or an average size or substantially uniform size within a range bounded by any two of the foregoing values, e.g., 0.01-10 microns, wherein the term “about” generally indicates no more than ±10%, ±5%, or ±1% from an indicated value. In some embodiments, at least 80%, 85%, 90%, 95%, 98%, or 99% of the particles have a size within any range bounded by any two of the exemplary values provided above. For example, at least 90% of the particles may have a size within a range of 0.1-10 microns or at least or more than 95% of the particles may have a size within a range of 0.1-20 microns, 0.01-10 microns, 0.1-5 microns, or 0.1-1 micron. In some embodiments, 100% of the particles have a size with a desired size range.

The polyalkylene oxide (PAO) can be any of the polyether polymer compositions well known in the art. The PAO is typically of a high enough molecular weight to be a solid at room temperature. The molecular weight of the PAO is typically at least or greater than 500 g/mol, 1000 g/mol, 5000 g/mol, 10,000 g/mol, 50,000 g/mol, or 100,000 g/mol (weight-average or number-average). The polyether polymer generally contains a multiplicity (generally at least or more than 10, 20, 30, 40, or 50) of carbon-oxygen-carbon (ether) groups in the backbone of the polymer. In some embodiments, the polyether polymer may or may not contain ether groups in the backbone but contains a multiplicity of ether groups in side chains, such as poly(ethylene glycol)methacrylate (PEGMA), which is also an example of a branched polyether polymer. For purposes of the invention, a branched polyether polymer should contain at least two, three, four, five, six, or more ether groups in each side chain. In some embodiments, the polyether polymer does not contain ether groups in side chains or is not a branched polymer.

In the case of homopolymers, the PAO generally possesses the formula HO—(CH₂CHR—O)ₙH, wherein n is typically at least or greater than 10, 20, 50, 100, 200, 500, 1000, or 5000 and R is typically H or a hydrocarbon group, such as methyl or ethyl. The PAO may be or include, for example, polyethylene oxide (PEO) or propylene oxide (PPO). The PAO may alternatively be denoted as a glycol, such as a polyethylene glycol (PEG), polypropylene glycol (PPG), or polybutylene glycol (PBG). In some embodiments, the PAO is a copolymer (e.g., diblock, triblock, alternating, or random) or a mixture of at least two different PAOs, such as PEO mixed with PPO. In the case of copolymers, the PAO contains at least two different types of polyether units, each within the scope of HO—(CH₂CHR—O)ₙ, e.g., a PEO-PPO diblock copolymer of the formula HO—(CH₂CH₂—O)ₙ—(CH₂CH(CH₃)—O)ₘ or a PEO-PPO-PEO or PPO-PEO-PPO triblock copolymer. In some embodiments, the PAO may be or include polybutylene oxide (PBO), i.e., where R in the formula above is ethyl, or alternatively, PBO may correspond to HO—(CH₂CH₂CH₂CH₂—O)ₙH (polytetrahydrofuran). In some embodiments, the PAO is a copolymer or a mixture of PBO and any of PEO and/or PPO. Typically, the PAO contains only one or more PAOs, i.e., without being copolymerized with or mixed with a non-polyether. In other embodiments, the PAO is copolymerized with or mixed with a non-polyether, such as polystyrene (PS), butadiene, or a polyester (e.g., polyethylene terephthalate), such as a PEO-b-PS, PEO-polybutadiene-PEO, or PEO-PET copolymer. The PAO is typically present in an amount of at least 0.1 wt % and up to 10 wt % of the solid electrolyte composition. In different embodiments, the PAO is present in an amount of precisely or about, for example, 0.1, 0.2, 0.5, 1, 1.5, 2, 2.5, 3, 3.5, 4, 4.5, 5, 6, 7, 8, 9, or 10 wt %, or an amount within a range bounded by any two of the foregoing values (e.g., 0.1-10 wt %, 1-10 wt %, 0.1-5 wt % or 1-5 wt %).

In another aspect, the present disclosure is directed to a method for producing the solid electrolyte composition described above. In a first step of the method, Li₂S, P₂S₅, a PAO, and a solvent are homogeneously mixed (blended) to form a liquid solution or liquid homogeneous dispersion of the Li₂S, P₂S₅, and PAO in the solvent. Methods for homogeneously mixing components in a liquid medium are well known in the art and any such method may be used. The Li₂S and P₂S₅ reactants may be included in any suitable molar ratio that results in a product of the formula xLi₂S.(1−x)P₂S₅ wherein x is a value within a range of 0.5-0.9, as described above. For example, to produce Li₃PS₄, a molar ratio of Li₂S and P₂S₅ of 3:1 should be used, which corresponds to x being 0.75. For purposes of the present invention, the PAO should be present in the mixture in an amount of 0.1-10 wt % of the solid electrolyte or within any sub-range therein, as described above.

The solvent should at least partially dissolve the Li₂S, P₂S₅, and PAO components. The term “partially dissolve” includes any level of dissolution, including substantial insolubility in the solvent (e.g., up to or below 1%, 0.5%, or 0.1%) or appreciable dissolution (e.g., at least or above 1%, 2%, 5%, 10%, 20%, or 50%). Typically, the solvent has a melting point of no more than or less than 100° C., and more typically, no more than or less than 50° C., 25° C., or 0° C. The solvent also typically has a boiling point of at least or above 60° C., 80° C., 100° C., 120° C., or 150° C., but typically up to or below 200° C., 250° C., or 300° C. In one embodiment, the solvent is or includes a nitrile solvent. The nitrile solvent contains at least one nitrile (CN) group. Some examples of nitrile solvents include acetonitrile, propionitrile, butyronitrile, and dinitrile solvents (e.g., succinonitrile, glutaronitrile, and adiponitrile). In another embodiment, the solvent is or includes an ether solvent. The ether solvent contains at least one ether (carbon-oxygen-carbon) group and may be linear, branched, or cyclic. Notably, the ether solvent should have a different composition than the PAO. Typically, the ether solvent has a molecular weight and melting point significantly below the PAO. Some examples of linear ether solvents include dibutyl ether, dihexyl ether, diphenyl ether, dimethoxyethane (monoglyme), diethylene glycol, diethylene glycol dimethyl ether (diglyme), diethylene glycol monomethyl ether, diethylene glycol diethyl ether, diethylene glycol monoethyl ether, diethylene glycol monobutyl ether, diethylene glycol dibutyl ether, triethylene glycol, triethylene glycol monomethyl ether, triethylene glycol dimethyl ether (triglyme), tetraethylene glycol, tetraethylene glycol monomethyl ether, tetraethylene glycol dimethyl ether (tetraglyme), pentaethylene glycol, pentaethylene glycol monomethyl ether, and pentaethylene glycol dimethyl ether. Some examples of branched ether solvents include diisopropyl ether, methyl t-butyl ether, di-t-butyl ether, and diisopentyl ether (isoamyl ether). Some examples of cyclic ether solvents include tetrahydrofuran (THF), tetrahydropyran, 1,4-dioxane, furfural, furfuryl alcohol, 2-methylfuran, 2,5-dimethylfuran, and the crown ether solvents (e.g., 12-crown-4, 15-crown-5, and 18-crown-6). The ether solvent may also include another functionality, such as an ester group, as found in propylene glycol methyl ether acetate (PGMEA). In another embodiment, the solvent is a carbonate solvent, such as ethylene carbonate (EC), propylene carbonate (PC), dimethyl carbonate (DMC), and/or ethyl methyl carbonate (EMC). In another embodiment, the solvent is an ester solvent, such as methyl acetate (MA), ethyl acetate (EA), n-propyl acetate, isopropyl acetate, methyl formate (MF), ethyl formate (EF), n-propyl formate (PF), n-butyl formate, t-butyl formate, methyl propionate (MP), ethyl propionate (EP), methyl butyrate (MB), and/or γ-butyrolactone. The solvent may alternatively be a lactam solvent, such as c-caprolactam, which may be in admixture with acetamide to form a eutectic solvent (see, e.g., Q. Cheng et al., “Full Dissolution of the Whole Lithium Sulfide Family (Li₂S₈ to Li₂S) in a Safe Eutectic Solvent for Rechargeable Lithium-Sulfur Batteries,” Angew. Chem. Intl. Ed., 58(17), 5557-5561, Apr. 16, 2019). In some embodiments, the solvent is a single solvent while in other embodiments the solvent is a mixture of two or more solvents.

In a second step of the method, the liquid solution or homogeneous dispersion described above is subjected to a process that substantially removes the solvent, except possibly for a trace of solvent that may remain as co-crystallized solvent. The solvent removing process may employ heating, reduced pressure (vacuum), or a combination of both to remove the solvent. Typically, the liquid solution or homogeneous dispersion is heated to a temperature of at least 50° C., 60° C., 70° C., or 80C° C. and up to 100° C., 120° C., 130° C., 140° C., 150° C., 200° C., 250° C., or 300° C. (or a range therein, e.g., 140° C. to 250° C.) to remove the solvent and produce the solid electrolyte composition. After the solvent is removed, the solid electrolyte may also be subjected to an annealing step, which may employ any of the temperatures above, typically up to about 200° C. A calcining step may also be employed, typically above 200° C. and up to 300° C. In some embodiments, the solvent removal step serves a dual function as an annealing step and/or calcining step or merges into an annealing step and/or calcining step. In other embodiments, solvent removal and annealing steps are conducted as distinct separate steps. In some embodiments, to reach the solvent removal, annealing, or calcining temperature, the temperature is gradually increased at a set ramping rate, such as 10° C./min, 5° C./min, 2° C./min, or 1° C./min, or a rate above or below any of the foregoing.

As mentioned earlier above, the solid electrolyte composition described above is generally amenable to material processing (e.g., by casting onto a substrate) to produce a shape (e.g., film or membrane) of the composition. A film or membrane of the electrolyte composition is particularly suited for construction of a lithium-ion battery. For example, the electrolyte composition may be placed in particulate form on a suitable substrate (e.g., an anode current collector, such as lithium foil on a substrate) and compressed with or without heating to form a compact and typically continuous layer. Alternatively, the liquid solution or liquid homogeneous dispersion containing the reactants described above may be cast onto a substrate and subjected to the solvent removal conditions described above to produce a continuous film of the solid electrolyte product on the substrate. The produced film generally has a thickness of no more than or less than 200 microns. In different embodiments, the film has a thickness of about, up to, or less than, for example, 0.5, 1, 5, 10, 20, 25, 30, 40, 50, 60, 70, 80, 90, 100, 120, 150, 180, or 200 microns or a thickness within a range bounded by any two of the foregoing values (e.g., 0.5-50 microns, 0.5-30 microns, 0.5-25 microns, 0.5-20 microns, 1-50 microns, 1-30 microns, 1-25 microns, or 1-20 microns). In preferred embodiments, the separator thickness is substantially uniform, such as by having a roughness less than a micron or so.

In another aspect, the invention is directed to a lithium-based battery in which any of the above-described solid electrolyte compositions is incorporated. The battery contains at least an anode, a cathode, and the solid electrolyte in contact with or as part of the anode and/or cathode. In some embodiments, the solid electrolyte is incorporated in the battery in the form of particles, typically as a film or membrane containing particles, as described above. In other embodiments, the solid electrolyte is incorporated in the battery in the form of a continuous film or membrane, as described above. In the battery, the particles or film of solid electrolyte can have any of the compositions, particle sizes, particle shapes, film morphologies, or film thicknesses, as described above, and combined selections thereof, as desired. In some embodiments, the lithium-based battery is a lithium metal (plate) battery, in which the anode contains a film of lithium metal. In other embodiments, the battery is a metal ion battery, in which the anode contains metal ions stored in a base material (e.g., lithium ions intercalated in graphite). Whether the battery contains a metal anode or metal-ion anode, the battery may be a single-use (primary) or rechargeable (secondary) battery.

In a particular embodiment, the battery is a lithium-based single use or rechargeable battery. Any of the solid electrolyte compositions described above can be incorporated as a solid electrolyte in contact with at least one of the anode (negative electrode) and cathode (positive electrode) of the lithium metal or lithium-ion battery. Alternatively, the solid electrolyte composition can be incorporated into a cathode of the battery (typically admixed with a binder material), and the anode and cathode may be in contact with the above-described solid electrolyte composition or any of the conventional liquid (e.g., polar solvent or aqueous) or solid electrolytes known in the art. The lithium metal battery may contain any of the components typically found in a lithium metal battery, such as described in, for example, X. Zhang et al., Chem. Soc. Rev., 49, 3040-3071, 2020; P. Shi et al., Adv. Mater. Technol., 5(1), 1900806 (1-15), January 2020; and X. -B. Cheng et al., Chem. Rev., 117, 15, 10403-10473 (2017), the contents of which are incorporated herein by reference. In some embodiments, the lithium metal battery contains molybdenum disulfide in the cathode. The lithium-ion battery may contain any of the components typically found in a lithium-ion battery, including positive (cathode) and negative (anode) electrodes, current collecting plates, a battery shell, such as described in, for example, U.S. Pat. Nos. 8,252,438, 7,205,073, and 7,425,388, the contents of which are incorporated herein by reference in their entirety. In some embodiments, the lithium-ion battery is more specifically a lithium-sulfur battery, as well known in the art, e.g., L. Wang et al., Energy Environ. Sci., 8, 1551-1558, 2015, the contents of which are herein incorporated by reference. In some embodiments, any one or more of the above noted components may be excluded from the battery.

In embodiments where the inventive solid electrolyte is in contact with an anode and cathode of the lithium-based battery but not incorporated into the cathode, the positive (cathode) electrode can have any of the compositions well known in the art, for example, a lithium metal oxide, wherein the metal is typically a transition metal, such as Co, Fe, Ni, or Mn, or combination thereof, or manganese dioxide (MnO₂), iron disulfide (FeS₂), or copper oxide (CuO). In some embodiments, the cathode has a composition containing lithium, nickel, and oxide. In further embodiments, the cathode has a composition containing lithium, nickel, manganese, and oxide, or the cathode has a composition containing lithium, nickel, cobalt, and oxide. Some examples of cathode materials include LiCoO₂, LiMn₂O₄, LiNiCoO₂, LiMnO₂, LiFePO₄, LiNiCoAlO₂, and LiNiₓMn₂₋ₓO₄ compositions, such as LiNi_{0.5}Mn1.5O₄, the latter of which are particularly suitable as 5.0V cathode materials, wherein x is a number greater than 0 and less than 2. In some embodiments, one or more additional elements may substitute a portion of the Ni or Mn. In some embodiments, one or more additional elements may substitute a portion of the Ni or Mn, as in LiNiₓCo₁₋ₓPO₄, and LiCuₓMn₂₋ₓO₄, materials (Cresce, A. V., et al., Journal of the Electrochemical Society, 2011, 158, A337-A342). In further specific embodiments, the cathode has a composition containing lithium, nickel, manganese, cobalt, and oxide, such as LiNiMnCoO₂ or a LiNi_{w-y-z}Mn_{y}Co_{z}O₂ composition (wherein w+y+z=1), e.g., LiNi_{0.8}Mn_{0.1}Co_{0.1}O₂. The cathode may alternatively have a layered-spinel integrated Li[Ni_{0.8}Mn_{2/3}]O₂ composition, as described in, for example, Nayak et al., Chem. Mater., 2015, 27 (7), pp. 2600-2611. To improve conductivity at the cathode, conductive carbon material (e.g., carbon black, carbon fiber, or graphite) is typically admixed with the positive electrode material. In some embodiments, any one or more of the above types of positive electrodes may be excluded from the battery.

The negative (anode) electrode may be lithium metal or a material in which lithium ions are contained and can flow. For lithium-ion batteries, the anode may be any of the carbon-containing and/or silicon-containing anode materials well known in the art of lithium-ion batteries. In some embodiments, the anode is a carbon-based composition in which lithium ions can intercalate or embed, such as elemental carbon, such as graphite (e.g., natural or artificial graphite), petroleum coke, carbon fiber (e.g., mesocarbon fibers), carbon (e.g., mesocarbon) microbeads, fullerenes (e.g., carbon nanotubes, i.e., CNTs), and graphene. The carbon-based anode is typically at least 70 80, 90, or 95 wt % elemental carbon. The silicon-containing composition, which may be used in the absence or presence of a carbon-containing composition in the anode, can be any of the silicon-containing compositions known in the art for use in lithium-ion batteries. Lithium-ion batteries containing a silicon-containing anode may alternatively be referred to as lithium-silicon batteries. The silicon-containing composition may be, for example, in the form of a silicon-carbon (e.g., silicon-graphite, silicon-carbon black, silicon-CNT, or silicon-graphene) composite, silicon microparticles, or silicon nanoparticles, including silicon nanowires. The negative electrode may alternatively be a metal oxide, such as tin dioxide (SnO₂), titanium dioxide (TiO₂), or lithium titanate (e.g., Li₂TiO₃ or Li₄Ti₅O₁₂), or a composite of carbon and a metal oxide. In other embodiments, the anode may be composed partially or completely of a suitable metal or metal alloy (or intermetallic), such as tin, tin-copper alloy, tin-cobalt alloy, or tin-cobalt-carbon intermetallic. In some embodiments, any one or more of the above types of negative electrodes may be excluded from the battery.

The positive and negative electrode compositions may be admixed with an adhesive (e.g., PVDF, PTFE, and co-polymers thereof) in order to be properly molded as electrodes. Typically, positive and negative current collecting substrates (e.g., Cu or Al foil) are also included. The solid electrolyte composition is typically incorporated in the form of film having any of the thicknesses described earlier above. The film of solid electrolyte is typically made to be in contact with at least one (more typically both) of the electrodes. The assembly and manufacture of lithium-based batteries are well known in the art.

Examples have been set forth below for the purpose of illustration and to describe certain specific embodiments of the invention. However, the scope of this invention is not to be in any way limited by the examples set forth herein.

### Examples

Overview

The following work reports a novel class of composite solid electrolytes containing amorphous Li₃PS₄ synthesized in situ with a PEO binder using a one-pot, solvent-mediated route. The solvent and thermal processing conditions have been found to have a dramatic impact on the Li₃PS₄ structure. Conducting the synthesis in THF resulted in crystalline β-Li₃PS₄ whereas acetonitrile led to amorphous Li₃PS₄. Annealing at 140° C. increased the Li⁺ conductivity of an amorphous composite (Li₃PS₄+1 wt. % PEO) by three orders of magnitude (e.g., from 4.5×10⁻⁹ to 8.4×10⁻⁶ S/cm at room temperature) due to: (i) removal of coordinated solvent and (ii) rearrangement of the polyanionic network. The PEO content in these composites was limited to 1-5 wt. % to ensure reasonable Li⁺ conductivity (e.g., up to 1.1×10⁻⁴ S/cm at 80° C.) while providing enough binder to facilitate scalable processing.

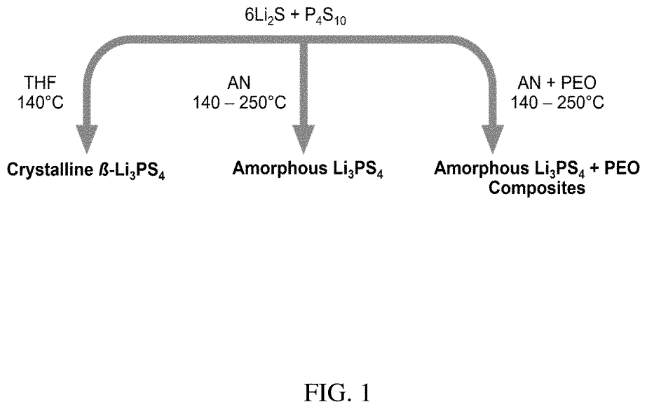

The present work describes the one-pot synthesis of a new class of amorphous Li₃PS₄/PEO composite SEs in which the PEO serves as a binder to improve material processability. Here, the Li₃PS₄ is synthesized in situ by blending the Li₂S, P₂S₅, and PEO in acetonitrile followed by thermal annealing (FIG. 1). Acetonitrile is removed after thermally annealing the electrolyte at 140-250° C. This approach permits production of a wide range of composites in which the Li+-conducting phase (Li₃PS₄) is intimately blended with the polymer binder (PEO). The effects of different solvents and heat treatments on the phase and micro/nanostructure evolution of the composite electrolytes were evaluated using X-ray diffraction (XRD), cryogenic transmission electron microscopy (cryo-TEM), Raman spectroscopy, and X-ray photoelectron spectroscopy (XPS).

Experimental Section

Synthesis of Li₃PS₄+PEO Composites: Amorphous Li₃PS₄-based SEs were prepared by dispersing Li₂S (Sigma-Aldrich), P₂S₅ (Sigma-Aldrich) and poly(ethylene oxide (PEO, 600 kDa, Sigma-Aldrich) in acetonitrile (AN, anhydrous, Sigma-Aldrich). The composites contained Li₂S and P₂S₅ in a 3/1 molar ratio, and the PEO content ranged from 0-56 wt. %. The dispersions were sealed in HDPE vials containing ZrO₂ milling media and blended on a Turbula Model T2F shaker-mixer for several hours to obtain homogenous slurries. The samples were subsequently dried under vacuum at 25-45° C. to remove excess solvent, and the resulting powders were annealed at temperatures up to 250° C. for at least 12 h. For comparison, crystalline β-Li₃PS₄ was prepared by blending Li₂S and P₂S₅ in a 3/1 molar ratio in tetrahydrofuran (THF, Sigma-Aldrich) followed by drying at 140° C. under vacuum overnight. Slurry cast SE films were prepared by dispersing amorphous Li₃PS₄+5 wt. % PEO in acetonitrile (18 wt. % solids) and blending on the Turbula shaker-mixer for 1 hour. The slurry was cast onto Cu foil (15 μm thick) using an 8 mil doctor blade and dried overnight under vacuum at room temperature. All syntheses, processing, and characterization were performed under an Ar atmosphere to mitigate air exposure.

X-Ray Photoelectron Spectroscopy (XPS): The powder samples were dispersed onto double-sided tape fixed to clean glass slides and placed in a vacuum transfer holder inside an Ar-filled glove box. The holder was evacuated and sealed in the glovebox load-lock before transferring to the X-ray photoelectron spectroscopy (XPS) instrument (Thermo Scientific Model K-Alpha XPS) which contained a monochromated, micro-focusing Al Kα X-ray source (1486.6 eV) with a variable X-ray spot size (30-400 μm). This work used the 400 μm X-ray spot size to maximize the signal intensity and to obtain an average surface composition over a large area. The instrument used a hemispherical electron energy analyzer equipped with a 128 multi-channel detector system. The base pressure in the analysis chamber was 3×10⁻¹⁰ mbar. Wide energy range survey spectra (0-1,350 eV) were acquired for qualitative and quantitative analysis using a pass energy setting of 200 eV. To assess the chemical bonding of identified elements, narrow energy range core level spectra were acquired with a pass energy setting of 50 eV. Data were collected and processed using the Thermo Scientific Avantage XPS software package (v 4.61). Spectra were charge corrected using the C 1 s core level peak set to 284.8 eV.

Electrochemical Characterization: The ionic conductivities of β-Li₃PS₄ and Li₃PS₄/PEO composite SE pellets were measured in symmetric cells containing carbon-coated Al blocking electrodes. To prepare these cells, the SE powder was compacted at 500 MPa for 1 minute at room temperature in a 13 mm pellet die using a hydraulic press. Carbon-coated Al disks (1/2″ diameter) were placed in both sides of the die prior to pellet pressing. The ejected pellet (ca. 0.5-1 mm thick) was sandwiched between stainless steel rods (1/2″ diameter), and heat shrink was applied to ensure concentric alignment of cell components. AC electrochemical impedance spectra of the cells were acquired at 25-80° C. at open-circuit using a 10 mV AC perturbation (unless indicated otherwise) over the frequency range 1×10⁶−0.5 Hz using a Bio-Logic SP-200 potentiostat/galvanostat.

The total ionic conductivity (σ_{Li}+, S/cm) was calculated at 25-80° C. using equation (1):

$${σ}_{{Li}^{+}} = \frac{x}{R \times A}$$

where x is the pellet thickness (cm), R is the real intercept from the Nyquist plots (Ω), and A is the electrode area (cm²). For graphical clarity, conductivity data is reported as log(σ_{Li+}) vs. 1000/T, but activation energies (Eₐ, eV) were calculated using the following relationship:

$${σ}_{{Li}^{+}} T = {Ae}^{\frac{- {E}_{a}}{R \times T}}$$

where A is a constant (S K cm⁻¹) and R is the universal gas constant (eV K⁻¹). Cells were thermally cycled at least 2 times to ensure reproducible conductivity measurements. Electrochemical measurements were performed inside an Ar-filled glovebox.

A Li|Li₃PS₄+1%PEO|Li symmetric cell was prepared by attaching Li electrodes (1/2″ diameter, approximately 45 μm thick on Cu foil) to both sides of the SE pellet (amorphous Li₃PS₄+1%PEO annealed at 140° C.). The Cu|Li|Li₃PS₄+1%PEO|Li|Cu ensemble was sandwiched between stainless steel rods (1/2″ diameter), and heat shrink was applied to ensure concentric alignment of cell components. The cell was cycled at current densities of 7.9-20 μA/cm² (1 h per half cycle) at room temperature inside an Ar-filled glovebox.

Raman Spectroscopy: Raman spectra were acquired with an Alpha 300 confocal Raman microscope (WITec, GmbH) using a solid-state 532 nm excitation laser, a 20× objective lens, and a grating with 600 grooves per mm. The laser spot size and power were approximately 1 μm and 100 μW, respectively. Representative Raman spectra were analyzed using WITec Project Plus software. Powder samples were hermetically sealed in an optical cell (EL-Cell) in an Ar-filled glovebox prior to Raman measurements to avoid air exposure.

X-ray Diffraction (XRD): XRD measurements were performed on a Scintag XDS 2000 powder diffractometer with Cu Kα radiation (λ=1.5406 Å) in the 2θ range of 10-80°. The operating voltage and current of the X-ray generator were 38 kV and 32-35 mA, respectively. Powders were mounted on glass slides and covered with Kapton tape to mitigate air exposure during XRD measurements.

Electron Microscopy: The morphology and elemental composition of Li₃PS₄/PEO pellets were assessed using scanning electron microscopy (SEM) and energy-dispersive X-ray spectroscopy (EDS, Bruker) with a Zeiss Merlin SEM using an accelerating voltage of 1-20 kV. Samples were loaded in a vacuum-tight sample stage described previously^{[53]} to avoid air exposure during sample transfer.

Samples for cryogenic transmission electron microscopy (cryo-TEM) were prepared by drop casting Li₃PS₄/PEO powders dispersed in acetonitrile onto lacey carbon TEM grids inside an Ar-filled glovebox. Specimens were exposed to ambient conditions for ca. 3 minutes during sample loading. Cryo-TEM measurements were conducted on an aberration-corrected FEI Titan (scanning) transmission electron microscope (S/TEM) operated at 300 kV using a Gatan Cryo Transfer holder cooled by liquid nitrogen. During TEM operation, the spatial resolution was ˜0.63 Å, and the electron dose flux was <1000 e⁻Å⁻²·s⁻¹. All images were analyzed using Digital Micrograph software (Gatan).

Results and Discussion

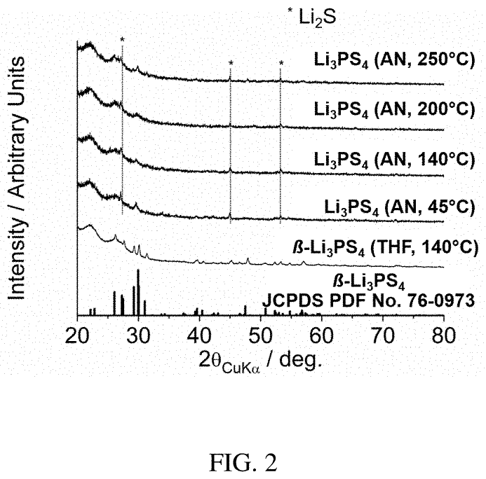

Li₃PS₄ powders were synthesized by a solvent-mediated route in which Li₂S and P₂S₅ were mixed in either tetrahydrofuran (THF) or acetonitrile (AN). When prepared in THF, the powders dried at room temperature contained co-crystallized solvent (denoted Li₃PS₄.3THF) which was removed by heating to 140° C. to yield crystalline β-Li₃PS₄. On the other hand, syntheses conducted in acetonitrile led to an amorphous Li₃PS₄ product, which contained weak reflections indexed to trace Li₂S and a broad peak at 2θ˜29.6° (FWHM˜0.6° compared to ˜0.2° for β-Li₃PS₄, see FIG. 2). Surprisingly, heating this amorphous Li₃PS₄ at 140-250° C. for ≥12 h did not induce crystallization of the expected β-Li₃PS₄ phase as typically reported. Instead, the material thermally decomposed at temperatures ≥200° C. as evidenced by grey discoloration of the powder and formation of a grey film which condensed outside the furnace's heating zone. The amorphous Li₃PS₄, which lacks discrete crystalline grains (shown later using cryogenic transmission electron microscopy, cryo-TEM), may be useful for mitigating unstable Li growth in SSBs.

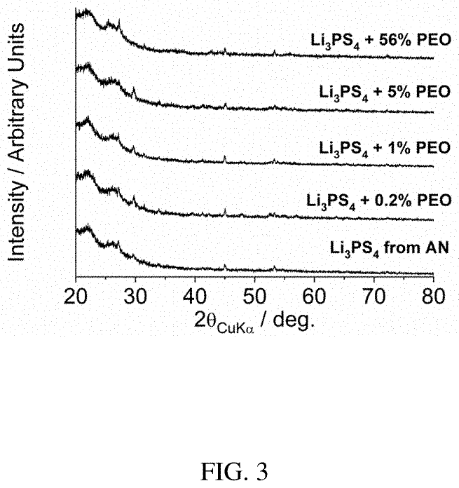

Developing composite SEs containing Li₃PS₄ and polymer binder was herein developed to facilitate processing of thin-film SEs. More particularly, new amorphous Li₃PS₄/poly(ethylene oxide) (PEO) composites were developed in which the Li₃PS₄ is synthesized in the presence of PEO binder, thus resulting in an intimate blend of the two components. The impact of PEO incorporation on the phase and microstructure of the SEs was evaluated by XRD, SEM, EDS, and cryo-TEM. FIG. 3 shows that XRD patterns of Li₃PS₄+PEO composites containing 0.2-56 wt. % PEO were very similar to that of amorphous Li₃PS₄ prepared from AN. Interestingly, while pure PEO exhibited a sharp peak at 2θ=˜24° due to the polymer's semi-crystalline structure at room temperature, this peak was absent for the PEO-containing composites. This finding indicates that PEO crystallinity was greatly suppressed in the composites, possibly due to coordination between Li₃PS₄ and the polymer's ether functional group. SEM and EDS analysis of cold-pressed pellets containing 1 and 56 wt. % PEO was conducted. The Li₃PS₄+1% PEO composite contained some visible surface pores, and a higher PEO content promoted a significantly smoother surface. EDS maps of these pellets showed a homogeneous distribution of C, O, P, and S, which indicates that the one-pot synthesis promotes good contact between Li₃PS₄ and PEO.

TEM was employed to further probe: (i) contact between the Li₃PS₄ and PEO and (ii) nanocrystalline domains which may exist in these amorphous materials. Lithium thiophosphates are notoriously difficult to study via TEM at room temperature due to their high beam sensitivity. Therefore, this study utilized cryo-TEM (holder cooled by liquid nitrogen) and low electron dose fluxes (<1000 e⁻Å⁻² s⁻¹) to minimize beam damage. Cryo-TEM images were taken of Li₃PS₄+PEO composites containing 1 and 56 wt. % polymer, respectively. The composites were almost entirely amorphous with no detectable nanocrystalline β-Li₃PS₄. However, these samples contained small domains (<50 nm) associated with: (i) crystalline Li₂S and (ii) PEO crystallites (d-spacing ˜2 nm) due to the low temperature of the cryogenic holder.

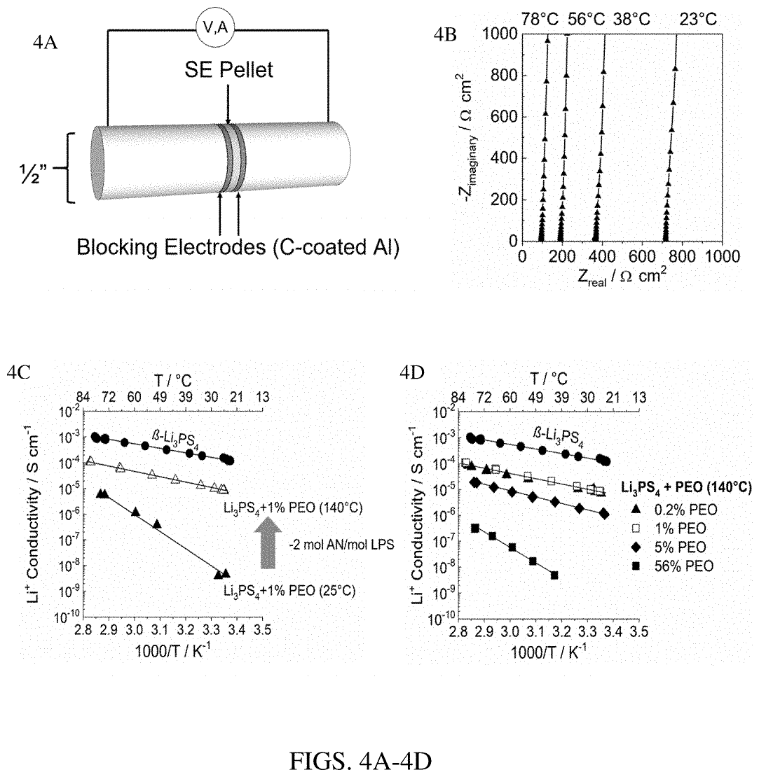

As shown in FIG. 4A, the Li+ conductivities of crystalline β-Li₃PS₄ and amorphous Li₃PS₄+PEO composites were evaluated through AC impedance measurements on the blocking cell configuration. Nyquist plots (FIG. 4B) of these cells exhibited vertical capacitive tails due to charge accumulation at the electrode/electrolyte interfaces. As shown in FIG. 4C, the crystalline β-Li₃PS₄ exhibited high Li⁺ conductivity (e.g., 1.2×10⁻⁴ S/cm at room temperature) with an activation energy of 0.36 eV, values which are in good agreement with previous reports on the crystalline polymorph (e.g., Z. Liu et al., J. Am. Chem. Soc., 135, 975, 2013). In comparison, the ionic conductivity of the polymer/ceramic composites varied greatly depending on the thermal treatment. For example, after drying under vacuum at 25° C., the conductivity of Li₃PS₄+1% PEO was 5 orders of magnitude lower than that of β-Li₃PS₄ (e.g., 4.5×10⁻⁹ S/cm at room temperature) due to the presence of coordinated AN. After heating to 140° C., the material evolved ˜2 mol AN/mol Li₃PS₄ (corresponding to ˜30 wt. % loss), and the ionic conductivity increased three orders of magnitude at room temperature (i.e., from 4.5×10⁻⁹ to 8.4×10−6 S/cm). The higher conductivity coincided with a lower activation energy (1.37 vs. 0.45 eV for samples dried at 25 and 140° C., respectively), which indicated that the coordinated AN hindered Li⁺ mobility and provided a less favorable energy landscape for long-range Li⁺ migration. The role of different thermal treatments on the composite's microstructure was explored using Raman spectroscopy and XPS as is discussed later in the text.

FIG. 4D shows the Li⁺ conductivity of Li₃PS₄+PEO composites heated at 140° C. as a function of polymer content. Samples with 0.2 and 1 wt. % PEO exhibited identical conductivities and activation energies within experimental error. Increasing the PEO content from 1 to 5 wt. % slightly decreased the conductivity (e.g., 1.1×10⁻⁶ S/cm at room temperature) due to the insulating nature of PEO. Higher PEO loading resulted in even lower conductivity, and the sample with 56 wt. % PEO could only be measured at elevated temperature (e.g., 4.8×10⁻⁹ S/cm at 42° C.) due to its higher resistance. Based on these findings, the polymer content in amorphous Li₃PS₄+PEO composites was limited to ca. 1-5 wt. % to ensure reasonable ionic conductivity while providing enough binder to facilitate processing.

Compared to the nanocrystalline β-Li₃PS₄, the lower conductivity of the Li₃PS₄+PEO polymer/ceramic composites may be attributed to: (i) the negligible conductivity of the polymer phase which contains no Li-based salt, (ii) the intrinsic properties of amorphous Li₃PS₄ which may contain Li—P—S bonding environments with lower Li+ mobility compared to β-Li₃PS₄ and (iii) the lower Li⁺ concentration in amorphous Li₃PS₄ as indicated by the presence of trace Li₂S from the XRD and cryo-TEM measurements. To better understand the near-order structure of the composites and how it changes with thermal treatment, Raman spectroscopy and XPS measurements were performed on Li₃PS₄+1% PEO.

Raman spectra were taken of amorphous composites containing 1% PEO before and after thermal treatments up to 250° C. When dried at room temperature, the sample showed several Raman-active bands in the range 100-600 cm⁻¹ in which various P—S stretches are expected. The bands at 395 and 435 cm⁻¹ are assigned to P—S vibrational modes of the P₂S₆²⁻ and PS₄³⁻ polyanions, respectively (C. Dietrich et al., Inorg. Chem., 56, 6681, 2017). The peak at 2,920 cm⁻¹ is attributed to the C—H stretch of coordinated AN. This C—H stretch was absent from all annealed samples, which indicates that the coordinated AN was removed at 140° C. In comparison, previous studies (e.g., H. Wang et al., J. Mater. Chem. A, 4, 8091, 2016) have shown that heat treatments at 200° C. are required to remove coordinated AN from β-Li₃PS₄, which suggests that the solvent is less strongly coordinated to amorphous Li₃PS₄. This finding indicates that the thermal processing window of Li₃PS₄+PEO prepared via one-pot synthesis is wider than that of materials prepared from only Li₂S, P₂S₅, and AN precursors.

In addition to changes caused by solvent removal, the Raman spectra of Li₃PS₄+1 wt. % PEO exhibited subtle changes in the range 390-430 cm⁻¹ upon heating due to rearrangement of the polyanionic network. More specifically, heating at 140-200° C. resulted in a new band at 408 cm⁻¹ (attributed to formation of P₂S₇⁴⁻ polyanions) and increased intensity ˜430 cm⁻¹ (attributed to PS₄³⁻) (Y. Wang et al., J. Ceram. Soc. Jpn., 124, 597, 2016). The relative ratio of PS₄³⁻ and P₂S₇⁴⁻ after different thermal treatments was qualitatively estimated based on the relative peak intensities at 408 and 430 cm⁻¹. Compounds with these polyanionic structures (e.g., Li₃PS₄ and Li₇P₃S₁₁) typically exhibit higher Li⁺ conductivity compared to structures containing P₂S₆²⁻ (e.g., Li₂P₂S₆) which was the predominant moiety in the unheated sample. Further heating to 250° C. caused thermal decomposition of the Li₃PS₄+PEO composite as evidenced by the appearance of an unknown broad band ˜1,300 cm⁻¹. Collectively, the Raman results indicate that the composites' higher Li⁺ conductivity after annealing at 140° C. was due to: (i) removal of coordinated AN and (ii) reorganization of the amorphous structure to form a more ionically conductive polyanionic framework.

To complement the Raman measurements, the near-surface structures of Li₃PS₄+1% PEO and β-Li₃PS₄ were studied using XPS. Core-level S 2p, P 2p, and Li 1 s spectra were studied. The S 2p and P 2p spectra of β-Li₃PS₄ exhibited doublets due to 2p1/2 and 2p3/2 spin-orbit splitting where the components were separated by 1.1 and 0.9 eV for S 2p and P 2p, respectively. These features are consistent with previous reports (e.g., L. Sang et al., Chem. Mater., 29, 3029, 2017) and indicate a single type of P—S bonding environment was present in β-Li₃PS₄ (i.e., isolated PS₄³⁻ tetrahedra). In comparison, the amorphous Li₃PS₄+1% PEO samples showed significantly broader signal in the S 2p spectra with additional features at 162.6-163.7 eV which are assigned to P₂S₆²⁻ and P₂S₇⁴⁻ polyanion structures. Notably, the sample annealed at 140° C. contained more P₂S₇⁴⁻ and less P₂S₆²⁻ compared to the unheated sample which is consistent with the above Raman findings. On the other hand, the P 2p spectra of the composites were very similar to that of the β-Li₃PS₄, which may be due to similar 2p binding energies of phosphorus in different polyanion structures (e.g., PS₄³⁻ vs. P₂S₇⁴⁻), thus making it difficult to resolve these subunits. The Li 1 s spectra of the composites were broader and shifted by +0.2 eV compared to β-Li₃PS₄ which indicates the amorphous Li₃PS₄ contained a wider distribution of local Li—P—S bonding environments which led to their lower Li+ conductivity. The XPS and Raman data collectively indicate important transformations in the PS₄³⁻, P₂S₆²⁻, and P₂S₇⁴⁻ polyanions during annealing. These structural variations have critical implications on the electrochemical performance of the composite SEs.

A Li|Li₃PS₄+1%PEO|Li symmetric cell was constructed to assess the (electro)chemical compatibility of the SE with Li metal. The performance of the cell cycled at 7.9 μA/cm² at room temperature was studied. During initial cycles, the cell overpotential was ca. 0.24 V (corresponding to an effective SE conductivity of 2×10⁻⁶ S/cm) and decreased by ˜12% after 100 hours, possibly due to improved Li wetting at the interface. Notably, the cell exhibited stable cycling performance over 150 hours at low current density which indicates the composite SE formed a kinetically-stabilized passive film at the Li/SE interface. When cycled at 20 μA/cm², the cell shorted after 10 cycles (1 hour per half cycle) due to unstable Li growth. Although amorphous/glassy SEs lack a discrete grain structure, Li may preferentially grow along defects (e.g., between discrete particles in cold-pressed pellets or along artificial Lipon-Lipon interfaces).

In conclusion, this work describes the development of a new class of polymer/ceramic composite solid electrolytes containing amorphous Li₃PS₄. To address processing difficulties encountered with β-Li₃PS₄, these materials are synthesized in situ with a PEO binder/network former using a one-pot solvent-mediated route. The structure of Li₃PS₄ was highly dependent on the solvent and thermal processing conditions. The polymer's crystallinity was largely suppressed in the composites, which indicates a strong coordination between the polymer's ether group and the amorphous Li₃PS₄.

The ionic conductivity of amorphous Li₃PS₄+PEO composites increased several orders of magnitude (e.g., up to 1.1×10⁻⁴ S/cm at 80° C.) after heating at 140° C. due to: (i) removal of coordinated acetonitrile and (ii) rearrangement of the amorphous structure to form a more ionically conductive polyanionic network. Raman spectroscopy and XPS measurements indicate that thermal annealing increased the amount of P₂S₇⁴⁻ and PS₄³⁻ units to promote higher Li⁺ conductivity. Overall, the solvent-mediated synthesis approach developed here can be applied to a wide range of composite sulfide-based SEs where the material structure and electrochemical properties can be tuned by modifying key processing variables (e.g., solvent, mixing protocol, and thermal post-treatment) which are prerequisite in manufacturing guidelines for future Li metal batteries.

While there have been shown and described what are at present considered the preferred embodiments of the invention, those skilled in the art may make various changes and modifications which remain within the scope of the invention defined by the appended claims.

What is claimed is:

1. A solid electrolyte composition comprising a homogeneous blend of lithium thiophosphate particles and a polyalkylene oxide, wherein said lithium thiophosphate particles have the formula xLi₂S.(1−x)P₂S₅ wherein x is a value within a range of 0.5-0.9, and wherein said polyalkylene oxide is present in an amount of 0.1-10 wt % of the solid electrolyte.

2. The solid electrolyte composition of claim 1, wherein said polyalkylene oxide is present in an amount of 0.1-5 wt % of the solid electrolyte.

3. The solid electrolyte composition of claim 1, wherein said polyalkylene oxide is present in an amount of 1-10 wt % of the solid electrolyte.

4. The solid electrolyte composition of claim 1, wherein said polyalkylene oxide is present in an amount of 1-5 wt % of the solid electrolyte.

5. The solid electrolyte composition of claim 1, wherein x is a value of about 0.75, which corresponds to said lithium thiophosphate particles having the approximate composition Li₃PS₄.

6. The solid electrolyte composition of claim 1, wherein said lithium thiophosphate particles are amorphous.

7. The solid electrolyte composition of claim 1, wherein said lithium thiophosphate particles are crystalline.

8. The solid electrolyte composition of claim 1, wherein said polyalkylene oxide comprises polyethylene oxide.

9. The solid electrolyte composition of claim 1, wherein said solid electrolyte is shaped as a film having a thickness of up to 200 microns.

10. A solid-state lithium-based battery comprising:
a) an anode;
(b) a cathode; and
(c) a solid electrolyte composition comprising a homogeneous blend of lithium thiophosphate particles and a polyalkylene oxide, wherein said lithium thiophosphate particles have the formula xLi₂S.(1−x)P₂S₅ wherein xis a value within a range of 0.5-0.9, and wherein said polyalkylene oxide is present in an amount of 0.1-10 wt % of the solid electrolyte.

11. The solid-state lithium-based battery of claim 10, wherein said polyalkylene oxide is present in an amount of 0.1-5 wt % of the solid electrolyte.

12. The solid-state lithium-based battery of claim 10, wherein said polyalkylene oxide is present in an amount of 1-10 wt % of the solid electrolyte.

13. The solid-state lithium-based battery of claim 10, wherein said polyalkylene oxide is present in an amount of 1-5 wt % of the solid electrolyte.

14. The solid-state lithium-based battery of claim 10, wherein xis a value of about 0.75, which corresponds to said lithium thiophosphate particles having the approximate composition Li₃PS₄.

15. The solid-state lithium-based battery of claim 10, wherein said lithium thiophosphate particles are amorphous.

16. The solid-state lithium-based battery of claim 10, wherein said lithium thiophosphate particles are crystalline.

17. The solid-state lithium-based battery of claim 10, wherein said polyalkylene oxide comprises polyethylene oxide.

18. The solid-state lithium-based battery of claim 10, wherein said solid electrolyte is shaped as a film having a thickness of up to 200 microns.

19. A method for producing a solid electrolyte composition, the method comprising:
(i) homogeneously mixing Li₂S, P₂S₅, a polyalkylene oxide, and a solvent to form a liquid solution or liquid homogeneous dispersion of the Li₂S, P₂S₅, and polyalkylene oxide in said solvent, wherein said solvent at least partially dissolves Li₂S, P₂S₅, and the polyalkylene oxide; and
(ii) heating the liquid solution or liquid homogeneous dispersion produced in step (i) to remove the solvent and produce the solid electrolyte composition, wherein the solid electrolyte composition comprises a homogeneous blend of lithium thiophosphate particles and the polyalkylene oxide, wherein said lithium thiophosphate particles have the formula xLi₂S.(1−x)P₂S₅ wherein x is a value within a range of 0.5-0.9, and wherein said polyalkylene oxide is present in an amount of 0.1-10 wt % of the solid electrolyte.

20. The method of claim 19, wherein the solvent comprises a nitrile solvent.

21. The method of claim 19, wherein the solvent comprises an ether solvent.

22. The method of claim 19, wherein said polyalkylene oxide is present in an amount of 0.1-5 wt % of the solid electrolyte.

23. The method of claim 19, wherein said polyalkylene oxide is present in an amount of 1-10 wt % of the solid electrolyte.

24. The method of claim 19, wherein said polyalkylene oxide is present in an amount of 1-5 wt % of the solid electrolyte.

25. The method of claim 19, wherein xis a value of about 0.75, which corresponds to said lithium thiophosphate particles having the approximate composition Li₃PS₄.

26. The method of claim 19, wherein said lithium thiophosphate particles are amorphous.

27. The method of claim 19, wherein said lithium thiophosphate particles are crystalline.
